(19) United States
(12) Patent Application Publication
(10) Pub. No.: US 2024/0149911 A1
(43) Pub. Date: May 9, 2024

(54) DUAL CONTROL SYSTEMS AND METHODS FOR OPERATING AN AUTONOMOUS VEHICLE

(71) Applicant: TuSimple, Inc., SAN DIEGO, CA (US)

(72) Inventors: Stephen W. HORTON, San Diego, CA (US); Sridhar KUMAR, Fremont, CA (US); Shimeng WANG, San Diego, CA (US); Makarand Vinayak PHATAK, Franklin, IN (US); Pankaj CHAURASIA, San Ramon, CA (US); Ruiliang ZHANG, San Diego, CA (US)

(21) Appl. No.: 18/501,279

(22) Filed: Nov. 3, 2023

Related U.S. Application Data
(60) Provisional application No. 63/422,904, filed on Nov. 4, 2022.

(51) Int. Cl. B60W 60/00

(52) U.S. Cl. CPC B60W 60/001; B60W 2420/52

(57) ABSTRACT

Systems and methods for deployment on an autonomous vehicle are provided. In some example embodiments, the system includes a first compute unit and a second compute unit, in which the first compute unit is configured to receive first information of the vehicle and an environment of the vehicle, generate a first control command based on the first information, and transmit the first control command to a controller of the vehicle to effectuate an autonomous operation of the vehicle; and the second compute unit is configured to receive second information of the vehicle and the environment of the vehicle, generate a second control command based on the second information, and only when a fault or failure of the first compute unit is detected, transmits the second control command to the controller of the vehicle to effectuate the autonomous operation of the vehicle.

### CROSS-REFERENCE TO RELATED APPLICATIONS

This patent application claims priority to and the benefit of U.S. Provisional Application No. 63/422,904, filed on Nov. 4, 2022. The contents of the aforementioned application are incorporated herein by reference in its entirety.

### TECHNICAL FIELD

The present document relates generally to autonomous vehicles. More particularly, the present document relates to dual control systems and methods for controlling at least partially autonomous operation of a motor vehicle.

### BACKGROUND

Autonomous vehicle (AV) technologies can provide motor vehicles that can safely navigate towards a destination with limited or no driver assistance. Safe navigation of an autonomous vehicle from one point to another may include the ability to generate timely control commands based on environmental data and operation parameter of the AV, and cause the AV to operate accordingly.

### SUMMARY

Systems and methods are described herein that can deploy an autonomous vehicle to navigate from a first point to a second point. In some embodiments, the vehicle can navigate from the first point to the second point with limited or no intervention of a human driver and to comply with instructions for safe and lawful operation. For example, at least partially autonomous navigation of the vehicle involves dual control systems and methods. Example embodiments disclose dual control by two compute units. In some embodiments, the two compute units receive substantially equivalent information and independently generate, based on the information, control commends, while the control commends generated by only one of the two compute units are used to control the operation of the vehicle; if it is detected that fault or failure occurs in the compute unit, the other compute unit takes over control almost instantaneously.

In one exemplary aspect, a system for deployment of an autonomous vehicle is provided. In some embodiments, the system includes a first compute unit and a second compute unit. In some embodiments, the first compute unit receives first information of the motor vehicle and an environment of the motor vehicle, generates a first control command based on the first information, and transmits the first control command to the motor vehicle to effectuate an autonomous operation of the motor vehicle. In some embodiments, the second compute unit receives second information of the motor vehicle and the environment of the motor vehicle, generates a second control command based on the second information, and only when a fault or failure of the first compute unit is detected, transmits the second control command to the motor vehicle to effectuate the autonomous operation of the motor vehicle.

In another exemplary aspect, a method for deploying an autonomous vehicle is provided. In a further exemplary aspect, a non-transitory computer-readable program storage medium having code stored thereon is provided. The code stored on the storage medium, when executed by a processor, causing the processor to implement a method for deploying an autonomous vehicle.

In a still further exemplary aspect, a system for deployment on an autonomous vehicle according to a redundancy rule is provided. In some embodiments, the system includes a first compute unit and a second compute unit as described elsewhere in the present document; and a vehicle controller configured to receive first control commands from the first compute unit and second control commands from the second control unit and selectively use, according to the redundancy rule, one of the first control commands or the second control commands to autonomously operate the vehicle. In still further exemplary aspects, a method and a non-transitory computer-readable program storage medium having code stored thereon are provided for deployment on an autonomous vehicle according to a redundancy rule.

In some embodiments, the systems, methods, and non-transitory computer-readable program storage medium having code stored thereon as disclosed herein are configured to deploy an operation of the autonomous vehicle at least partially autonomously.

The above and other aspects and their implementations are described in greater detail in the drawings, the descriptions, and the claims.

### BRIEF DESCRIPTION OF THE DRAWINGS

For a more complete understanding of this document, reference is now made to the following brief description, taken in connection with the accompanying drawings and detailed description, where like reference numerals represent like parts.

FIG. 1 illustrates an example motor vehicle in accordance with some embodiments of the present document.

FIG. 2 shows an example system including a blade server in accordance with some embodiments of the present document.

FIG. 3 illustrates an architecture of an example system in accordance with some embodiments of the present document.

FIG. 4 shows a block diagram of an exemplary compute unit in accordance with some embodiments of the present document.

FIG. 5 shows a block diagram of an exemplary CPU module in accordance with some embodiments of the present document.

FIG. 6 shows a block diagram of an exemplary GPU module in accordance with some embodiments of the present document.

FIG. 7 shows a block diagram of an exemplary VCU module in accordance with some embodiments of the present document.

FIG. 8 shows a block diagram of an exemplary sensor unit stack in accordance with some embodiments of the present document.

FIGS. 9-10B show block diagram of portions of an exemplary system in accordance with some embodiments of the present document.

FIG. 11 shows a block diagram of an exemplary system in accordance with some embodiments of the present document.

FIG. 12 shows a flowchart of a process for deploying an autonomous vehicle in accordance with some embodiments of the present document.

### DETAILED DESCRIPTION

Vehicles traversing highways and roadways are legally required to comply with regulations and statutes in the course of safe operation of the vehicle. For autonomous vehicles (AVs), particularly autonomous tractor trailers, the ability to recognize a malfunction in its systems and stop safely can allow for a lawful and safe operation of the vehicle. Described below in detail are systems and methods for a safe and lawful operation of an autonomous vehicle on a roadway, including the execution of maneuvers that bring the autonomous vehicle in compliance with the law while signaling surrounding vehicles of its condition.

It is understood that features described in various portions of the present disclosure can be combined. Like reference numerals may denote like components or operations.

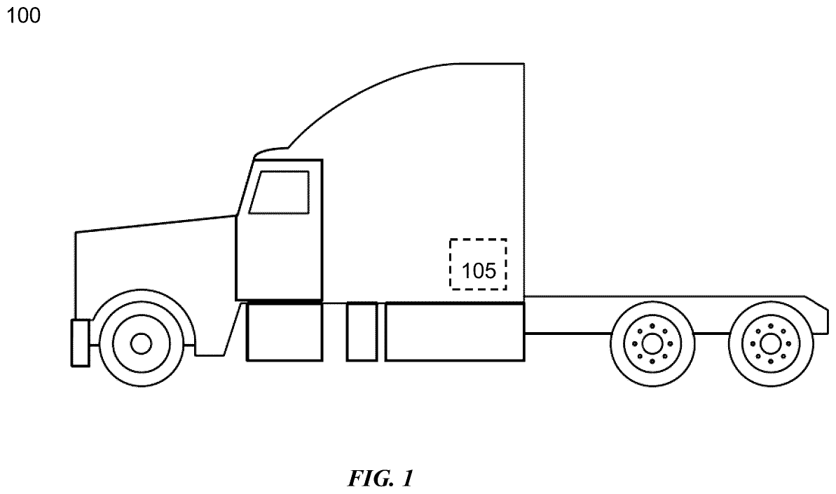

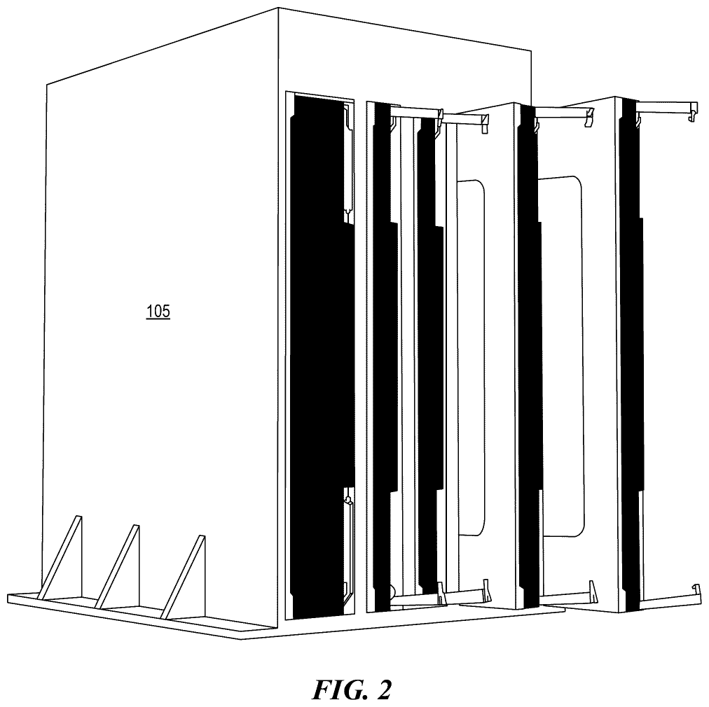

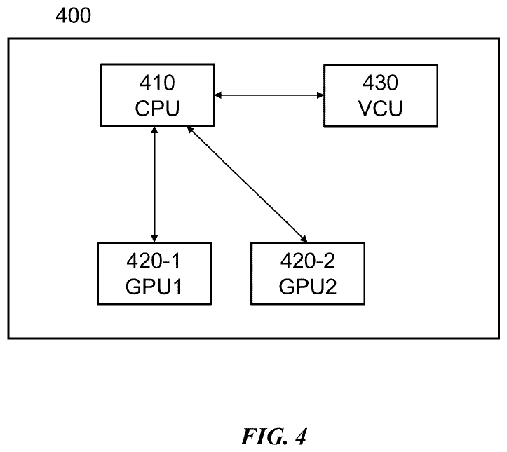

FIG. 1 shows a motor vehicle (or simply vehicle for brevity) 100 in accordance with some embodiments of the present document. The vehicle 100 may include a tractor of a semi-trailer truck, a passenger car, etc. The vehicle 100 may be a motor vehicle with full or limited autonomous operation capacity. The vehicle 100 includes a system 105 for deployment of an autonomous vehicle 100. As illustrated in FIG. 2, the system 105 may include a modular blade server including a plurality of blade modules operably connected to each other through, e.g., a backplane. The modular blade server design may help manage the interface and connectors of the system 105 to other systems and makes it easy to repair and maintain the components of the system 105, when there is any hardware related issue occurring and/or detected. Additionally, different components in the system 105 can be allocated in one blade module or same board depending on their requirements on printed circuit board (PCB) design and physical sizes. For example, a central processing unit (CPU) module and a vehicle control unit (VCU) can be put on one blade module (see, e.g., FIG. 4), while a program database (PDB) can be integrated into the CPU board.

In some embodiments, the system 105 is scalable by at least one of adding an additional blade module, replacing or removing one of the plurality of blade modules, or modifying a configuration of one of the plurality of blade modules. For instance, if a sensor is broken, or an upgrade version of a sensor or a different type of sensor becomes available, the system 105 can be conveniently adjusted by replacing or adding a new blade module with a suitable new data connector, appropriate storage capacity, compute capacity, etc., or a combination thereof, to implement the sensor upgrade, addition, or replacement.

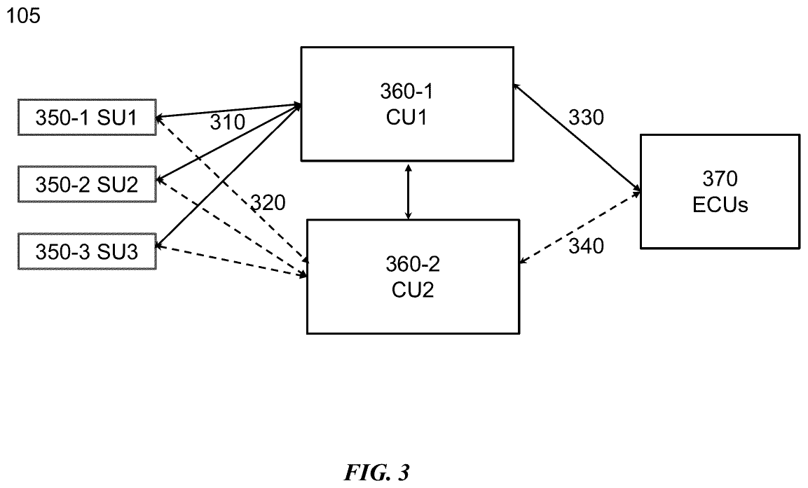

Various components of the system 105 may be operably connected using a point-to-point connection as illustrated as arrows each connecting two components in FIGS. 3-11. A point-to-point connection may offer one or more of benefits in the information (e.g., sensor data, control commands, etc., or a combination thereof) exchange in the context of autonomous driving. Example benefits are provided here for illustration purposes and not intended to be limiting. A point-to-point connection may be straightforward to set up and configure. An individual connection is typically dedicated to a specific purpose and involves fewer variables, making it easier to manage and troubleshoot. A point-to-point connection may reduce or minimize the risk of crosstalk, which may occur when signals interfere with each other in a multi-component environment. Accordingly, a point-to-point connection may result in improved signal integrity and reduced data errors. A point-to-point connection may have low latency in data transmission because there are no intermediate components or network routing to contend with. Point-to-point connections can be easily scaled by adding or removing connections as needed. This flexibility may be valuable because the number (or count) of components involved in the autonomous operation of a vehicle or a component itself may change over time. A point-to-point connection can provide a deterministic communication needed for precise control by ensuring that signals and/or data arrive reliably and on time. Point-to-point connections may allow for customization of a communication protocol and data format between components. In some embodiments, this level of customization can be achieved in specialized applications where standard protocols may be insufficient, without interfering with other components operably connected via other connections (e.g., point-to-point connections) independent from the customized connection. Point-to-point connections can isolate components from one another, reducing the risk of one component affecting the operation of another. This may be useful in an autonomous operation of a vehicle where fault tolerance is low and/or reliability is needed for safety considerations.

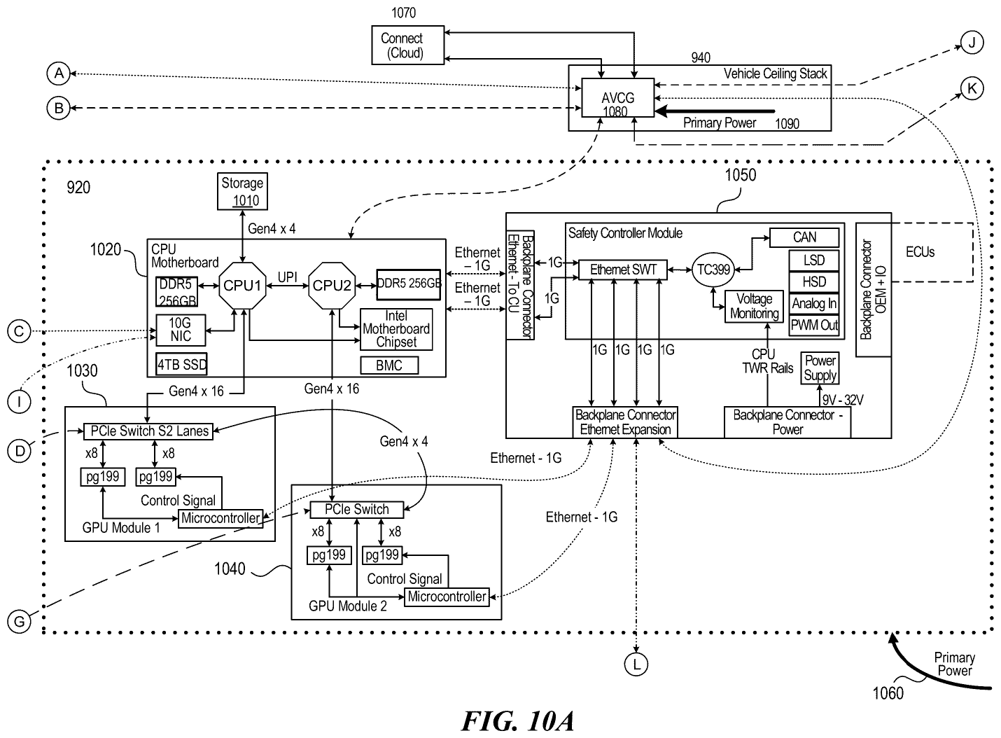

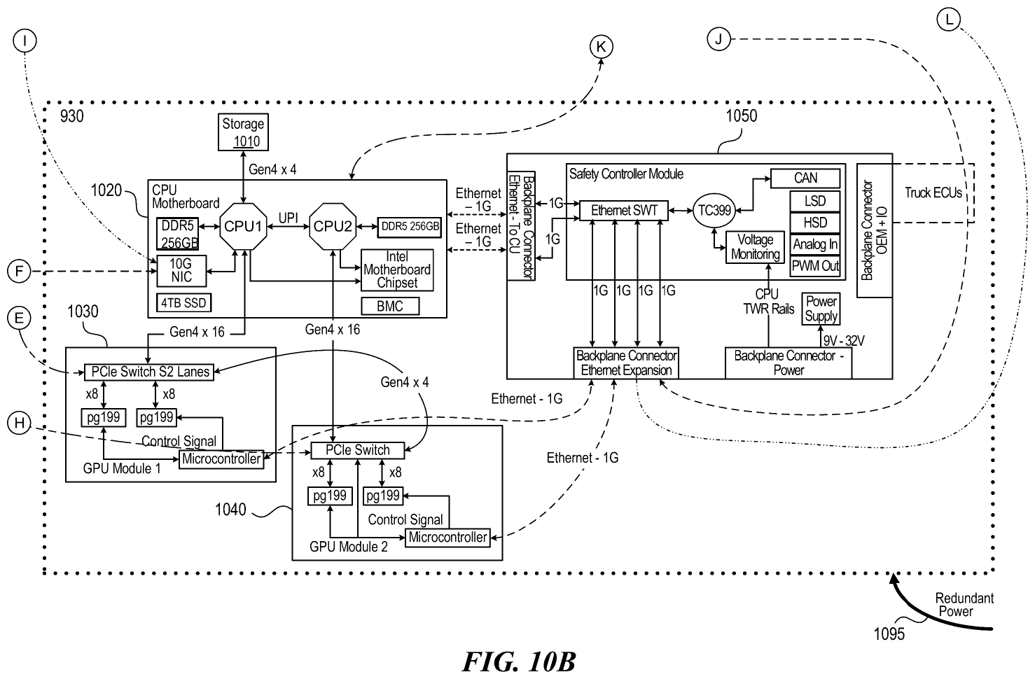

The system 105 may be an onboard system that is installed on the vehicle 100. The system 105 may communicate with a cloud server (e.g., cloud server 1070 as illustrated in FIG. 10A) regarding the vehicle 100, e.g., the condition, location, operation status, environment, etc., of the vehicle 100, and/or receive information from the cloud server for controlling the operation of the vehicle 100. The system 105 may include an oversight sub-system, e.g., the Advanced Vehicle Control/Guidance (AVCG) 1080 as illustrated in FIG. 10A. In some embodiments, the oversight sub-system may be remote from the vehicle 100.

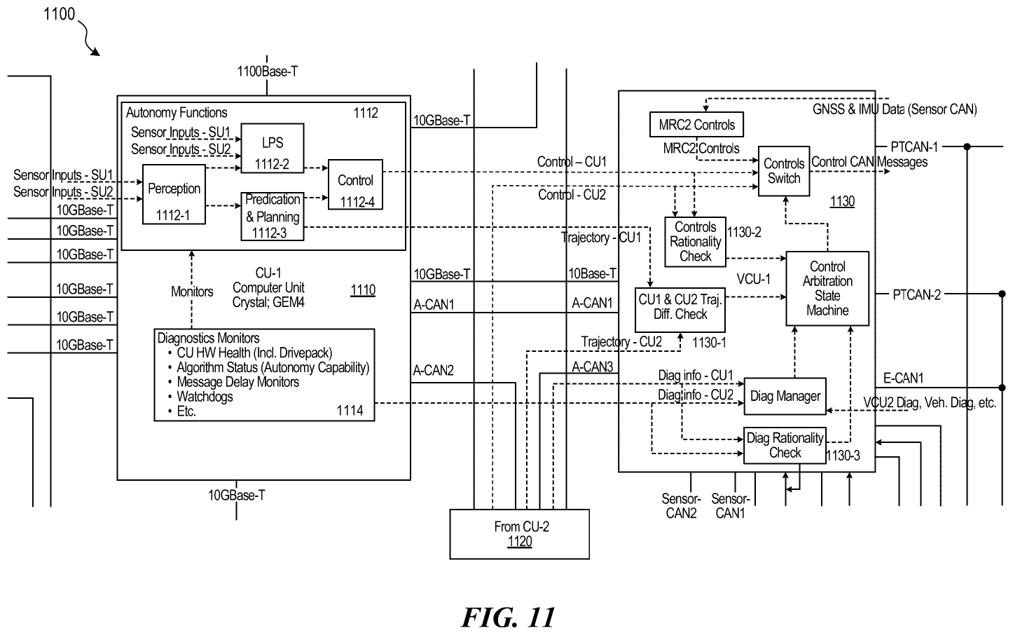

In some embodiments, the oversight sub-system may determine performance parameters of the vehicle 100 (e.g., an autonomous vehicle, an autonomous truck, a passenger car) including any of: data logging frequency, compression rate, location, data type; communication prioritization; how frequently the autonomous vehicle is serviced (e.g., how many miles between services); when to perform a minimal risk condition (MRC) maneuver while monitoring the vehicle's progress during the maneuver; when to hand over control of the autonomous vehicle to a human driver (e.g., at a destination yard); ensuring a vehicle passes a pre-trip inspection; ensuring a vehicle performs or conforms to legal requirements at checkpoints and weight stations; ensuring a vehicle performs or conforms to instructions from a human at the site of a roadblock, cross-walk, intersection, construction, or accident; or the like, or a combination thereof. In some embodiments, the oversight sub-system may be configured to detect a fault or failure (e.g., a fault or failure beyond a tolerable threshold) of a portion of the system 105 (e.g., a compute unit). For example, the oversight sub-system may be implemented as a diagnostics monitor SW modules 1114 and the VCU 1130 as illustrated in FIG. 11. See relevant description of FIG. 11.

Merely by way of example, when the system 105 detects that a fault or failure (e.g., a fault or failure that exceeds a tolerable threshold) has occurred in one or all compute units (e.g., 920 in FIG. 10A, 930 in FIG. 10B, CU-1 1110 and CU-2 in FIG. 11) of the system 105, the system 105 may activate an emergency maneuver. Exemplary emergency maneuvers include causing the vehicle to a stop, generating a notification (to a cloud server, to a law enforcement or emergency response agency), giving control of the vehicle to a third party (e.g., a cloud server that has appropriate authority, and/or capacity). In some embodiments, when such a third party receives a request to take over control of the vehicle 100, or determines that a fault or failure has occurred in the vehicle 100, the third party may take over control of the operation of the vehicle 100. For instance, the third party may send a control command or control signal to cause the vehicle to have an emergency stop, cause the vehicle 100 to drive to a nearest policy station, hospital, etc.

As another example, in response to detecting a fault or failure of a compute unit, the system 105 (e.g., VCU 1130 in FIG. 11) may take a remedial action. For example, a first compute unit (e.g., 920 in FIG. 10A, CU-1 1110 in FIG. 11) is the primary compute unit configured to generate and transmit first control commands to a vehicle controller to effectuate an autonomous operation (or partially autonomous operation) of the vehicle; a second compute unit (e.g., 930 in FIG. 10B, CU-2 1120 in FIG. 11) functions as a secondary or redundant compute unit configured to generate second control commands which are not transmitted to the vehicle controller. The system 105 (e.g., VCU 1130 in FIG. 11) may be configured to monitor whether the first compute unit operates normally, and in response to detecting a fault or failure (e.g., a fault or failure beyond a tolerable threshold) of the first compute unit, the system 105 (e.g., VCU 1130 in FIG. 11) may take a remedial action by terminating the transmission of the first control commands to the vehicle controller controlling the operation of the vehicle and causing the second compute unit to transmit the second control commands to the vehicle controller to effectuate the autonomous (or partially autonomous) operation of the vehicle.

In some embodiments, the system 105 may include a vehicle controller configured to receive control commands independently generated by different compute units, e.g., first control commands from a first compute unit and second control commands from a second control unit, and selectively use one of the first control commands or the second control commands according to a redundancy rule. In some embodiments, the redundancy rule specifies to use the first control commands as a default option, and switch to the second control commands in case of detection of a failure in the first compute unit.

FIG. 3 shows an example of the system 105 in accordance with some embodiments of the present document. The system 105 may include three sensor units (SU), SU1 350-1, SU2 350-2, and SU3 350-3. The system 105 may include two compute units (CU), a first compute unit CU1 360-1 and a second compute unit CU2 360-2. The system 105 may include electronic control units (ECUs) 370. A bidirectional arrow between two components indicates that information exchange between the two components is bidirectional and that one of the components may receive information from and provide information to the other of the two components. Each of the three sensor units, SU1 350-1 through SU3 350-3, may be operably connected to the first compute unit CU1 360-1 via an interface 310 illustrated as a solid line with bidirectional arrows such that the sensor unit may transmit information (e.g., sensor data) to and receive information (e.g., control signal) from the first compute unit CU1. A sensor unit may be operably connected to a plurality of sensors including, e.g., a camera, a microphone, a light detection and ranging (LiDAR) sensor, a radar sensor, an ultrasound sensor, a positioning or navigation sensor, or the like, or a combination thereof. The sensor unit may receive sensor data acquired by one or more of the plurality of sensors operably connected thereto and/or transmit control signals to one or more of the plurality of sensors. Example control signals may include signals to control or configure the operation of a sensor operably connected to a sensor unit (e.g., resolution, refresh rate of sensor data acquisition, the orientation of a sensor (e.g., the angle of the sensor unit, or a change thereof), or the like, or a combination thereof. Each of the three sensor units, SU1 350-1 through SU3 350-3, may also be operably connected to the second compute unit CU2 360-2 via an interface 320 illustrated as a dashed line with bidirectional arrows such that the sensor unit may transmit information (e.g., sensor data) to and receive information (e.g., control signal) from the second compute unit CU2 360-2. The interface 310 may be independent from the interface 320 such that data transmission via the interface 310 may be independent from data transmission via the interface 320. The interface 310 and the interface 320 may be different interfaces of a same type. Merely by way of example, one or both of the interface 310 and the interface 320 may be a controller area network (CAN) interface. In some embodiments, the interface 310 may be a controller area network (CAN) interface. The first compute unit CU1 360-1 may be operably connected to the ECUs via an interface 330. The second compute unit CU2 360-2 may be operably connected to the ECUs 370 via an interface 340 that is independent from the interface 330.

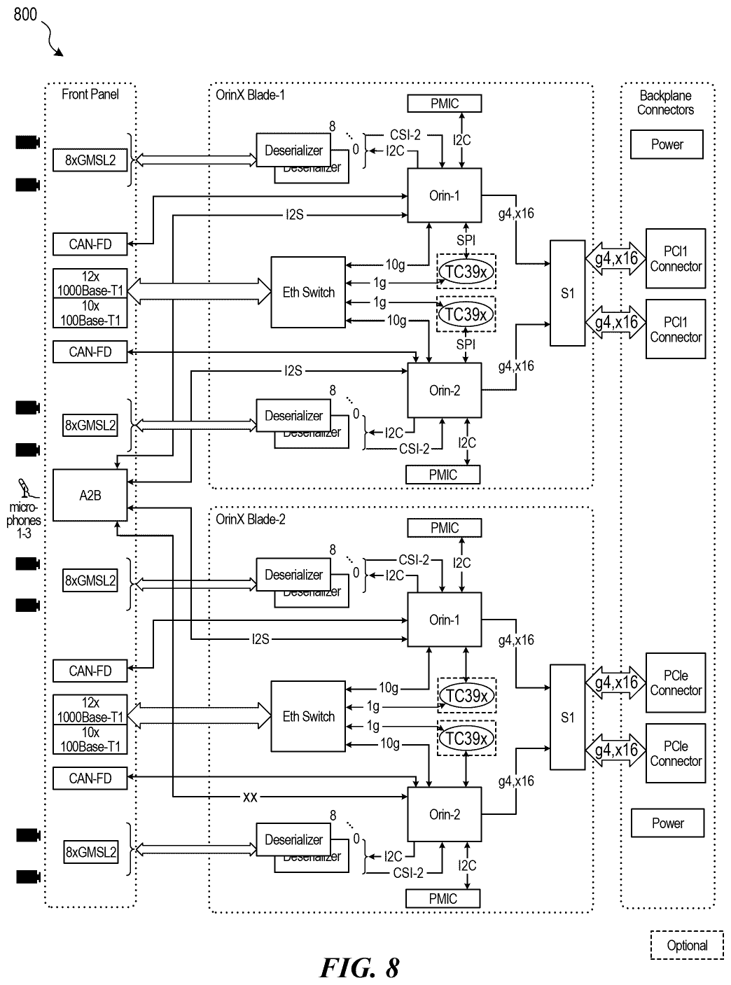

Merely by way of example, one or more of the sensor units may be implemented on a blade module; the first compute unit CU1 360-1 and the second compute unit CU2 360-2 may each be implemented on a blade module. In some embodiments, each compute unit may be operably connected to two sensor units (see, e.g., FIGS. 8-11).

In some embodiments, one of the compute units may be used or designated as a primary compute unit, and the other a secondary or redundant compute unit. In some embodiments, the primary compute unit and the redundant compute unit may have substantially symmetrical or identical configuration; that is, the primary compute unit and the redundant compute unit may include same components operably connected with each other in a same way. Merely by way of example, the primary compute unit and the redundant compute unit may include a same number (count) of central processing unit (CPU) modules, a same number (count) of graphics processing unit (GPU) modules, a number (count) of vehicle control units (VCUs), and these components are operably connected to each other in a same way. It is understood that two compute units are shown in FIG. 3 for illustration purposes only and not intended to be limiting. The system 105 may include more than two compute units.

FIG. 4 shows an exemplary block diagram of a compute unit 400 in accordance with some embodiments of the present document. The compute unit 400 may include a CPU module 410, two GPU modules 420-1 and 420-2, and a VCU 430. The CPU module 410 may be operably connected to GPU1 420-1, GPU2 420-2, and VCU 430, and exchange information with each of them bidirectionally.

The CPU module 410 may include at least one of a CPU, a CPU motherboard, a storage unit, a board management controller (BMC), a motherboard chipset, a network interface controller (NIC), or the like, or a combination thereof. At least some of the components of the CPU module 410 may be deployed on the CPU motherboard. In some embodiments, the storage capacity of the CPU module may be fixed assigned to different components of the CPU module, e.g., equally or unequally between different CPUs of the CPU module 410. In some embodiments, the storage capacity of the CPU module 410 may be dynamically assigned to different components of the CPU module 410, e.g., between different CPUs of the CPU module 410, based on a need for a storage capacity in one or more of the CPUs of the CPU module 410.

Either one of the GPU1 420-1 or GPU 420-2 may include at least one of a GPU, a microcontroller, a GPU carrier board, a switch, a data interface, a power connector, or the like, or a combination thereof.

The VCU 430 may provide an interface between the system 105 and ECUs of the vehicle 100. The VCU 430 may convert a control command from the system 105 to a control signal and transmit to the vehicle 100 (e.g., a vehicle actuator) via an ECU. Examples of the control signal include at least one of an engine torque request, a brake request, or a steering wheel angle request. In some embodiments, safety relevant functions and maintenance requirement card (MRC) functions may also run in the VCU 430. For instance, the VCU 430 may perform a check on the control commands and relevant information to determine if the control commands are valid, and/or if a compute unit is functioning properly, before converting the control commends to control signals.

In operation, the sensor data from the sensor units as illustrated as SU1 350-1 through SU3 350-3 in FIG. 3 may be transmitted to one or both of GPU1 420-1 and GPU2 420-2 for processing, and resultant information may be provided to the CPU module 410 for further processing in order to generate a control command. The control command may be transmitted to the VCU 430, and then to one or more vehicle actuators via one or more of the ECUs (e.g., ECUs 370 as illustrated in FIG. 3). The VCU 430 may perform some checks on the control commands and relevant information to determine if the control commands are valid, and/or if a compute unit is functioning properly. The VCU 430 may convert a valid control command to a control signal, and transmit the control signal to a vehicle actuator of the vehicle 100 via an ECU for controlling the operation of the vehicle 100. An ECU may be an original equipment manufacturer (OEM) ECU.

The compute unit 400 may be implemented on a blade module or a blade server (e.g., a modular blade server as illustrated in FIG. 2). The compute unit 400 may be the first compute unit, the second compute unit, and/or one of a plurality of compute units described elsewhere in the present document.

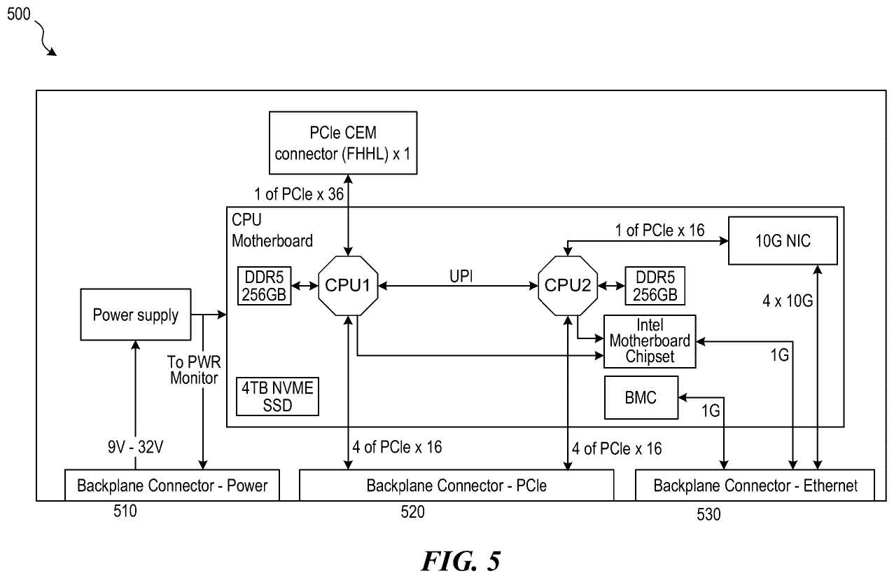

FIG. 5 shows a block diagram of an exemplary CPU module 500 in accordance with some embodiments of the present document. The CPU module 500 provides an example of the CPU module 410 of the compute unit 400. As illustrated, the exemplary CPU module 500 has two CPUs, CPU1 and CPU2 (e.g., Intel 4th Gen Xeon CPUs (Sapphire Rapids)), a Double Data Rate 5 (DDR5) memory (e.g., storage capacity of 512 GB in total, and 256 GB per CPU), and a nonvolatile memory express (NVMe) solid state drive (SSD) (e.g., storage capacity of 4 TB) on its CPU motherboard. Besides, a BMC, a 10G NIC, and a motherboard chipset (e.g., an Intel motherboard chipset) are deployed on the CPU motherboard. The CPU module 500 also provides different types of interfaces/connectors. For example, the CPU module 500 may include one 9V-32V power connector (e.g., 510), eight peripheral component interconnect express (PCIe) Gen5 slots (e.g., 520) each with a 16-lane configuration, two 1G ethernet ports (e.g., 530), four 10G ethernet ports, and one 16-lane PCIe Gen5 card electromechanical (CEM) connector. One or more of these connectors/interfaces may be implemented on the backplane of the CPU motherboard. It is understood that specific parameters, e.g., the generation, model number, protocol, configuration, manufacturer, etc., of a connector or interface, the number/count of a type of connector/interface, memory device, processor, etc., are provided here for illustration purposes and not intended to be limiting.

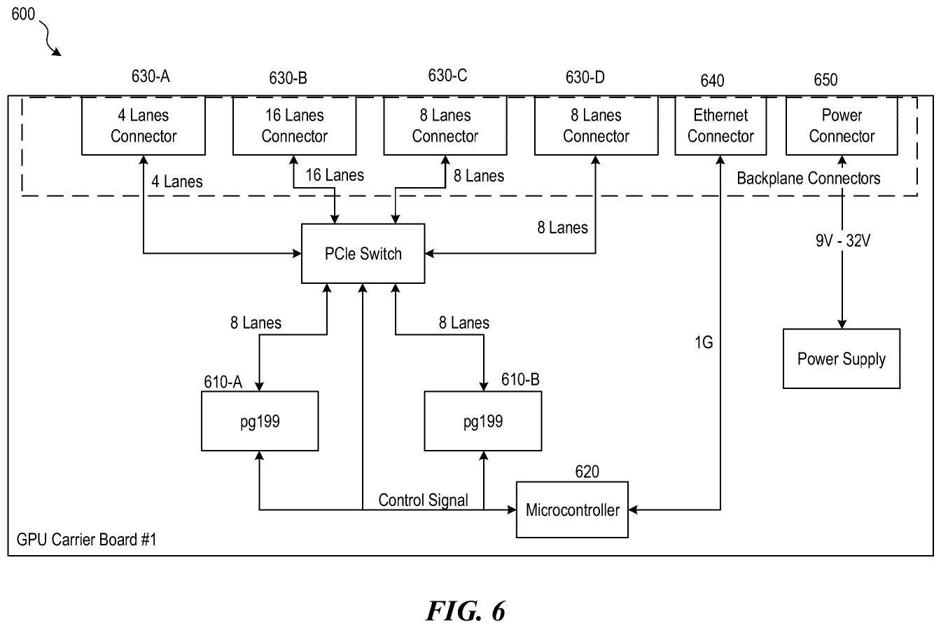

FIG. 6 shows a block diagram of an exemplary GPU module 600 in accordance with some embodiments of the present document. The GPU module 600 provides an example of the GPU module of a compute unit 400, e.g., GPU1 420-1, GPU2 420-2. As illustrated, the exemplary GPU module 600 includes two GPUs 610 (individually identified as 610-A and 610-B) (e.g., NVIDIA pg199), which are connected via, e.g., an 8-lane PCIe to a 52-lane PCIe Gen4 switch. Each of the two GPUs 610 of the GPU module 600 is configured to receive control signals from a microcontroller 620. The microcontroller 620 is used for controlling power supply and reset, and monitoring voltage and temperature of the GPUs 610. The microcontroller 620 has an Automotive Safety Integrity Level (ASIL)-D capability. The GPU module 600 (also referred to as GPU carrier board) has a plurality of backplane connectors including, e.g., one 1G ethernet connector 640, one 9V-32V power connector 650, and 4 separate PCIe connectors (e.g., one 4 lanes 630-A, one 16 lanes 630-B, and two 8 lanes 630-C and 630-D).

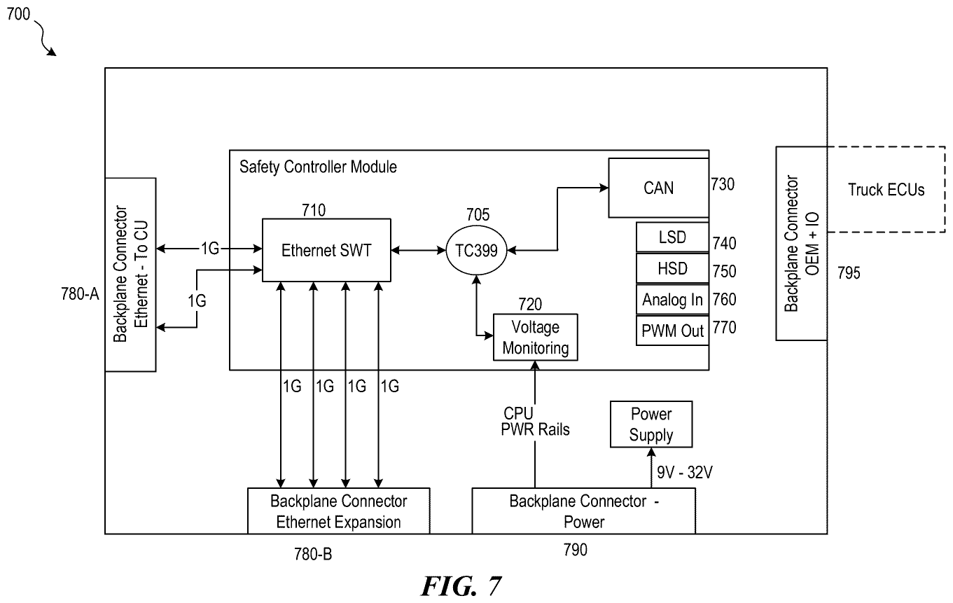

FIG. 7 shows a block diagram of an exemplary VCU module 700 in accordance with some embodiments of the present document. The VCU module 700 provides an example of the VCU 430. As described elsewhere in the present document, the VCU 430 may be integrated into or operably connected with the compute unit 400. As illustrated, the exemplary VCU module 700 may be hosted on a microcontroller 705 (e.g., an ASIL-D capable microcontroller such as an Infineon 32-bit TC399 microcontroller), which also fulfills the automotive grade safety requirements. There is a voltage monitoring system 720 deployed to monitor the CPU power supply voltage status through CPU power rails. An ethernet switch 710 (e.g., an 802.1AS ethernet switch) is involved for time alignment of data coming from different sources through ethernet. Varieties of interfaces are provided on the backplane connectors. Exemplary interfaces include one or more (e.g., twelve) CAN flexible data-rate (FD) interfaces 730, one or more (e.g., four) low side driver (LSD) connectors 740, one or more (e.g., eight) high side driver (HSD) connectors 750, one or more (e.g., twelve) analog input ports 760, one or more (e.g., sixteen) pulse width modulation (PWM) output ports 770, one or more (e.g., six) ethernet connectors 780 (individually illustrated as 780-A and 780-B) (e.g., 1G ethernet connector), a power supply connector 790 (e.g., a 9V-32V power supply connector), a port 795 (e.g., OEM+Input/output (IO) port) configured to allow an operable connection to with one or more ECUs of the vehicle (e.g., a truck), or the like, or a combination thereof. Merely by way of example, the backplane ethernet connector 780-A may be configured to facilitate a connection between the VCU module 700 to a compute unit.

FIG. 8 shows a block diagram of an exemplary sensor unit stack 800 in accordance with some embodiments of the present document. The sensor unit stack 800 may include one or more sensor units, e.g., sensor units SU1 350-1, sensor units SU2 350-2, and sensor units SU3 350-3. Multiple sensor units may be integrated in a blade module as the sensor unit stack 800. The sensor unit stack 800 is configured to solve a systemic risk due to one or more factors including, e.g., network switch failure, data loss and delay in transmission between sensors and the system 105, or the like, or a combination thereof. It can provide stable data transmission between sensors and server, services of sensor control and management, and synchronous data transmission for multi-sensors.

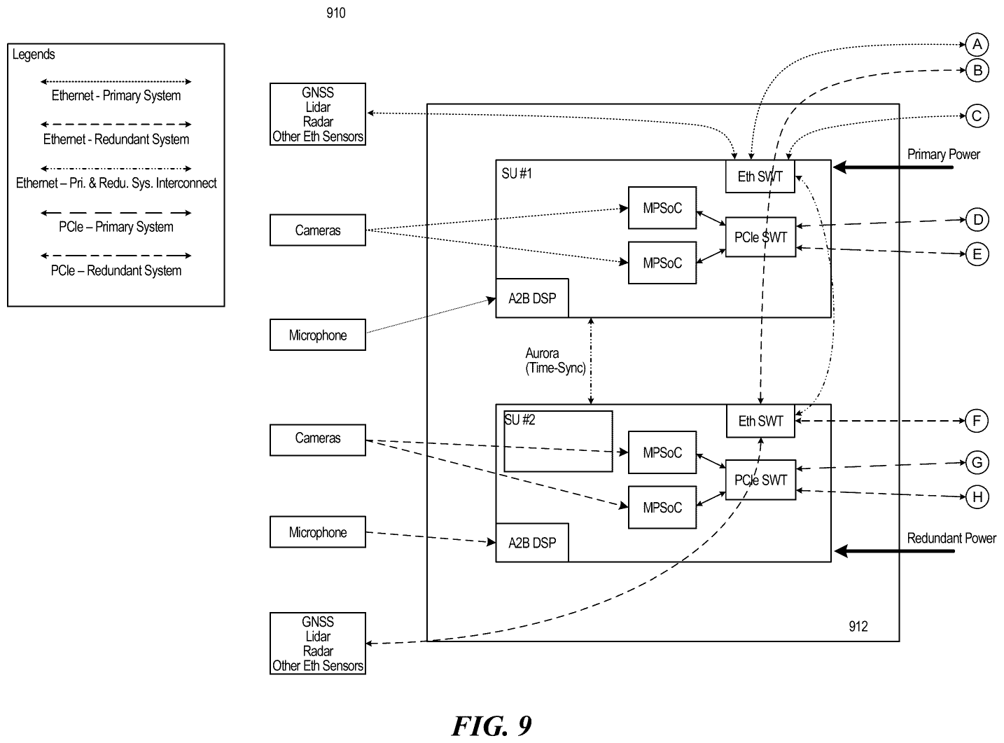

As illustrated, the exemplary sensor unit stack 800 includes two identical sensor units including, e.g., two Dual-OrinX boards denoted as Orin X Blade-1 and Orin X Blade-2, respectively). Each Dual-OrinX board has two NVIDIA OrinX (denoted as Orin-1 and Orin-2, respectively) System-On-a-Chip (SoC), one ethernet switch (denoted as “Eth Switch”) supporting 1G and 10G speeds, two Power Management Integrated Circuits (PMICs), sixteen Gigabit Multimedia Serial Link 2 (GMSL2) deserializers, one 32-lanes PCIe Gen4 switch, and as optional two ASIL-D capable safety microcontroller (e.g., Infineon TC39x). As illustrated, each of the two sensor units are operably connected to a plurality of sensors including, e.g., cameras, one or more microphones. Merely by way of example, a primary camera set transmits acquired image data to a sensor set (e.g., Orin X Blade-1 as illustrated in FIG. 8, SU #1 as illustrated in FIG. 9) via GMSL2 protocols, and the data from those GMSL2 serializer camera modules then need to be deserialized and fed to the SoC (e.g., Orin-1 as illustrated in FIG. 8 and multi-processor SoC as illustrated in FIG. 9).

The exemplary sensor unit stack 800 provides a rich interface setup, in order to transfer the sensor data to a compute unit. On the front panel, multiple (e.g., thirty-two) Gigabit Multimedia Serial Link 2 (GMSL2) interfaces (e.g., sixteen per Dual-OrinX board, eight per OrinX) are used to connect with cameras, microphones, multiple (e.g., four) CAN FDs for inertial measurement units (IMUs), multiple (e.g., twenty-four) 1000BASE-T1 ports, and multiple (e.g., twenty) 100BASE-T1 ports for transferring lidar and/or radar sensor data, and an Automotive Audio Bus (A2B) interface is used to collect microphone audio. On the backplane, there are multiple PCIe connectors (e.g., four 16-lane PCIe Gen4 connectors) and multiple power supply connectors (e.g., two 9V-32V power supply connectors). In some embodiments, each sensor unit in the sensor unit stack 800 may have an independent power supply through a power supply connector. Various components in the sensor unit stack 800 may be operably connected using a point-to-point connection as illustrated as arrows each connecting two components in FIG. 8. Components shown in dashed boxes may be optional components of the exemplary sensor unit stack 800.

FIGS. 9 through 10B show block diagrams of portions of an exemplary system 900 in accordance with some embodiments of the present document. The system 900 provides an example of the system 105. The portion 910 illustrated in FIG. 9 includes the sensor unit stack operably connected to sensors. The portion 920 illustrated in FIG. 10A includes a first compute unit, e.g., a primary compute unit. The portion 930 illustrated in FIG. 10B includes a second compute unit, e.g., a secondary or redundant compute unit. The portion 940 illustrated in FIG. 10A includes a vehicle ceiling stack. Various components of the system 105 may be operably connected using a point-to-point connection as illustrated as arrows each connecting two components in FIG. 9. One or more of the connections may be achieved using an ethernet connection (e.g., 100M, 1G), GMSL2, or the like, or a combination thereof. One or more of the connections may be wired using a cable. The cable may be suitable for an automotive environment. For instance, the cable may be temperature protected, weather protected, motion protected, etc. One or more of the connections may be achieved via an interface/connector, switch, e.g., PCIe Gen4/Gen5 connectors. In FIGS. 9 through 10B, the dotted line illustrates an ethernet connection between a component and a primary system (SU #1); the dashed line illustrates an ethernet connection between a component and a redundant system (SU #2); the dash-double-dotted line illustrates an ethernet interconnection between the primary system (SU #1) and the redundant system (SU #2); the long dashed line illustrates a connection between the primary system (SU #1) and a PCIe connector; the long-dash-double-short-dashed line illustrates a connection between the redundant system (SU #2) and a PCIe connector. Same letters A through L in two of FIGS. 9 through 10B illustrate respective connections. One or both of SU #1 and SU #2 may have an Ethernet interface, a PCIe interface, etc.

FIG. 9 shows the portion 910 including the sensor unit stack 912 operably connected to sensors. The sensors may be external and not part of the system 900, but in communication with the system 900 via one or more sensor units, e.g., sensor unit SU #1, sensor unit SU #2 as illustrated. The sensors may include at least one of a camera, an audio sensor, a microphone a light detection and ranging (LiDAR) sensor, a radar sensor, an ultrasound sensor, or a positioning or navigation sensor (e.g., a global navigation satellite system (GNSS) sensor).

The sensor unit SU #1 and the sensor unit SU #2 may form a sensor unit stack 912 (e.g., the same as or similar to the sensor unit stack 800 as illustrated in FIG. 8). The two sensor units SU #1 and SU #2 may communicate with each other or both be connected to a master clock so that they are time synchronized. For instance, a cloud-oriented database engine solution (e.g., Aurora) may be employed to achieve the synchronization.

In some embodiments, the sensor unit SU #1 and the sensor unit SU #2 may receive sensor data from different sensors. For instance, the sensor unit SU #1 may receive sensor data from a navigation sensor (e.g., GNSS), a lidar sensor, a radar sensor, a camera, a microphone, etc. In some embodiments, the sensor unit SU #2 may receive sensor data from a different camera, a different microphone, etc., than the sensor unit SU #1. Merely by way of example, a first camera set is configured to transmit acquired image data to SU #1, and a secondary camera set is configured to transmit acquired image data to SU #2. In some embodiments, the sensor unit SU #2 may receive sensor data from the same sensors as the sensor unit SU #1. The sensor unit SU #1 and the sensor unit SU #2 may be operably connected to different power sources. For instance, the sensor unit SU #1 may be operably connected to a first power source (e.g., a primary power source), and the sensor unit SU #2 may be operably connected to a second power source (e.g., a redundant power source). As illustrated, the sensor units SU #1 and SU #2 may include two multi-processor (MP) SoC.

FIG. 10A and FIG. 10B show compute units 920 and 930, respectively. The compute units 920 and 930 may be, e.g., a primary compute unit, a secondary compute unit as illustrated in FIGS. 3 and 4, respectively. The compute unit 920/930 may include a storage unit 1010, a CPU module 1020, two GPU modules including GPU module 1 1030 and GPU module 2 1040, and a VCU 1050. The compute unit 920 may be operably connected to a power supply 1060 (e.g., a primary power supply). The compute unit 930 may be operably connected to a power supply 1095 (e.g., a redundant power supply). More descriptions regarding these various components of the compute unit 920/930 may be found elsewhere in the present document. See, e.g., FIGS. 4-7 and relevant descriptions thereof, which are not repeated here.

FIG. 10A illustrates a vehicle ceiling stack 940. The vehicle ceiling stack 940 includes an Advanced Vehicle Control/Guidance (AVCG) 1080. The AVCG 1080 may be operably connected to a cloud service 1070. The cloud service 1070 may have storage capacity, processing capacity, etc. For instance, via the AVCG 1080, information of the vehicle 100 may be transmitted to the cloud 1070 for storage, processing, etc., and information from the cloud service 1070 may be transmitted to the vehicle 100. Exemplary information of the vehicle 100 include operation status, parameters, environmental data of the environment of the vehicle 100, etc. Exemplary information from the cloud service 1070 to the vehicle 100 include a notification (e.g., weather information, traffic information), an overriding control command or signal (e.g., in a case of an emergency when all the compute units of the system 105 fail) for operating the vehicle 100 (e.g., causing the vehicle 100 to have an emergency stop), etc. The AVCG 1080 may be operably connected to a power supply 1090 (e.g., a primary power supply as illustrated, a redundant power supply). It is understood that although component 940 is termed as “vehicle ceiling stack,” it does not mean that the component has to be installed on or in the ceiling of the vehicle 100. Instead, it can be installed at a suitable location of the vehicle 100 other than on or in the ceiling thereof.

FIG. 11 shows a block diagram of an exemplary system 1100 in accordance with some embodiments of the present document. The system 1100 provides an example of the system 105. The system 1100 may include a first compute unit CU-1 (also referred to as CU1) 1110, a second compute unit CU-2 (also referred to as CU2) 1120, and a VCU 1130. The system 1100 may also include sensor units SU1 and SU2. Various components of the first compute unit CU-1 1110 may be divided, based on functions, into dynamic driving tasks (DDT) software (SW) modules 1112 and diagnostics monitor SW modules 1114. The DDT SW modules 1112 may include a perception module 1112-1, a location positioning system (LPS) module 1112-2, a prediction & planning module 1112-3, and a control module 1112-4.

In some embodiments, the DDT SW modules 1112 may receive sensor data (or referred to as sensor inputs) from sensor units SU1 and SU2, and determine a desired trajectory and vehicle control commands based on the sensor inputs. The sensor inputs from sensor units SU1 and/or SU2 may be transmitted to the perception module 1112-1 and/or the LPS module 1112-2 of the DDT SW modules 1112. At least a portion of the DDT SW modules 1112 may also receive, e.g., environment data regarding the environment of the vehicle 100, location data from LPS module 1112-2, and use it in the determination. The DDT SW modules 1112 may output a planned trajectory generated by, e.g., the prediction & planning module 1112-3, control commends generated by, e.g., the control module 1112-4 of the DDT SW modules 1112.

In some embodiments, the diagnostics monitor SW modules 1114 may be configured to monitor the execution of DDT for timing and errors reported by the DDT SW modules 1112. The outputs of the diagnostics monitor SW modules 1114 may include, e.g., no errors being detected, minimal risk condition (MRC) 1 capable, MRC 3 capable, MRC 2 only, etc. The output may relate to or suggest a remedial or emergency action to take. For example, an output of MRC 2 may suggest that a minimum risk maneuver (MRM) is needed to put the vehicle in a safe state.

For example, the diagnostics monitor SW modules 1114 may include compute unit hardware (HW) health monitoring (HM). Merely by way of example, HM may provide the following features: monitoring of different rails on the board; power sequencing at start-up; log critical errors including power failures, the number (or count) of soft resets, watchdog failures; and control hardware communications and activity to maintain vehicle safety. In some embodiments, the diagnostics monitor SW modules 1114 may monitor algorithm status to assess, e.g., autonomy capability of the system 105. In some embodiments, the diagnostics monitor SW modules 1114 may monitor, e.g., message delays, watchdogs, etc. In some embodiments, the diagnostics monitor SW modules 1114 may constitute at least part of the oversight sub-system described elsewhere in the present document. See, e.g., FIG. 3 and relevant description thereof. Additional information in this regard may be found in, e.g., International Application Publication No. WO2023009987 entitled “Systems and methods for operating an autonomous vehicle,” filed Jul. 25, 2022, the contents of which are incorporated by reference.

The second compute unit CU-2 1120 may be configured substantially the same as the first compute unit CU-1 1110. The description of first compute unit CU-1 1110 applies to the second compute unit CU-2 1120, and not repeated.

The VCU 1130 illustrated in FIG. 11 exemplifies a software architecture of a redundant L4 ECU architecture. As illustrated, the VCU 1130 is configured to go through a series of steps to determine which vehicle control trajectory is safe and robust. The steps may include the MRC monitor and executor, as well as diagnostic checks of the overall health and the states of both CU1 and CU2. One or more of these steps may be referred to as rationality checking and facilitate an arbitration between which CU (e.g., of CU1 and CU2) to listen to for the final output trajectory. Merely by way of example, the VCU 1130 may monitor the operation of the first compute unit CU-1 1110 and the second compute unit CU-2 1120 and/or detect fault or failure by comparing information from the first compute unit CU-1 1110 and the second compute unit CU2 1120. For instance, the VCU 1130 (e.g., at CU1 & CU2 trajectory different check module 1130-1) may compare the trajectories independently predicted by the first compute unit CU-1 1110 and the second compute unit CU2 1120. For trajectories close to a point of interest (e.g., a destination), a small envelope (e.g., a small deviation) between the trajectory determined by the first compute unit CU-1 1110 and the trajectory determined by the second compute unit CU2 1120 is allowed. For trajectories far away from a point of interest (e.g., a destination), a big envelope (e.g., a larger deviation than for the situation for trajectories close to a point of interest) between the trajectory determined by the first compute unit CU-1 1110 and the trajectory determined by the second compute unit CU2 1120 may be allowed. In some embodiments, the VCU 1130 may compare timestamps of corresponding information independently predicted by the first compute unit CU-1 1110 and the second compute unit CU2 1120. If a deviation between the timestamps of corresponding information independently predicted by the first compute unit CU-1 1110 and the second compute unit CU2 1120 exceeds a threshold, the VCU 1130 may determine, e.g., whether there may be fault or failure in the first compute unit CU-1 1110 or the second compute unit CU2 1120, whether the first control commend or the second control commend is valid, etc. In some embodiments, various results of the trajectory comparisons may be considered in combination to determine a checksum end to end, and the VCU 1130 makes one decision based on the checksum.

The VCU 1130 (e.g., at controls rationality check module 1130-2) may perform a rationality check of the control commands independently generated by the first compute unit CU-1 1110 and the second compute unit CU2 1120. For instance, the VCU 1130 may check the information regarding timestamps, range, etc., of the control commands independently generated by the first compute unit CU-1 1110 and the second compute unit CU2 1120, generate a checksum, and make one rationality decision based on the checksum.

The VCU 1130 (e.g., at diagnostics rationality check module 1130-3) may perform a compute unit diagnostics rationality check. Output of the diagnostics monitor SW modules 1114 may be double checked. For example, the VCU 1130 may check the information regarding timestamps, program flow, etc., in connection with the output of the diagnostic s monitor SW modules 1114, generate a checksum, and make one rationality decision based on the checksum.

In some embodiments, the VCU 1130 may constitute at least part of the oversight sub-system described elsewhere in the present document. See, e.g., FIG. 3 and relevant description thereof.

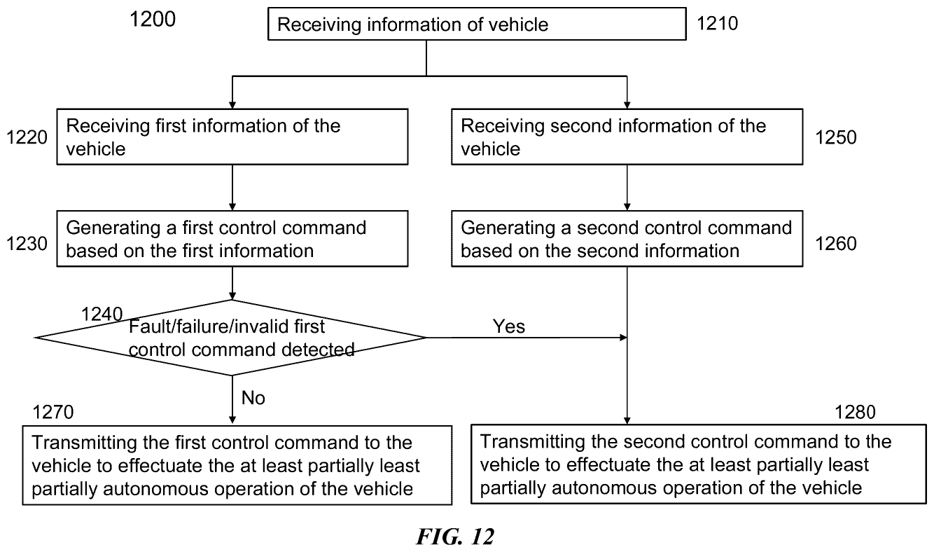

FIG. 12 shows a flowchart of a process for deploying an autonomous vehicle in accordance with some embodiments of the present document. The process may be performed on the system 105.

In 1210, the sensor units of the system 105 may receive information. The information may include sensor data acquired by one or more sensors as described elsewhere in the present document. In some embodiments, the information may also include an operation parameter of the vehicle 100. The sensor units may send the received information to a first compute unit and a second compute unit substantially simultaneously. In some embodiments, one or more operation parameters of the vehicle 100 may be directly transmitted to the first compute unit and the second compute unit.

In 1220, the first compute unit receives first information of the vehicle 100. In 1250, the second compute unit receives second information of the vehicle 100. The first information may be substantially equivalent to the second information. The receipt of the first information on the first compute unit and the receipt of the second information on the second compute unit may occur substantially simultaneously.

In 1230, the first compute unit generates a first control command based on the first information. In 1260, the second compute unit generates a second control command based on the second information. The generation of the first control command is independent of the generation of the second control command.

In 1240, an assessment is made as to whether the first compute unit is at fault or fails, or whether the first control commend is valid (e.g., passed the diagnostic monitor performed by the diagnostic monitor modules 1114 and/or the rationality check performed on the VCU 1130 as described in FIG. 11). If it is determined that the first compute unit is not at fault or does not fail, and/or if the first control commend is valid, in 1270 the first control commend is transmitted to the vehicle (e.g., a vehicle actuator) to effectuate the at least partially least partially autonomous operation of the vehicle.

If it is determined that the first compute unit is at fault or fails, and/or if the first control commend is invalid, the first control commend is not transmitted to the vehicle; instead, in 1280, the second control commend is transmitted to the vehicle (e.g., a vehicle actuator) to effectuate the at least partially least partially autonomous operation of the vehicle. For example, as described elsewhere, a valid control command may be converted to a control signal, and the control signal may be transmitted to a vehicle actuator via, e.g., an ECU, and the vehicle actuator may cause the vehicle 100 to operate accordingly.

In some embodiments, both the first control command and the second control command are transmitted to a processing unit or device, e.g., a vehicle controller. The vehicle controller may selectively use one of the first control command or the second control command according to a redundancy rule. In some embodiments, the redundancy rule specifies to use the first control commands as a default option, and switch to the second control command in case of detection of a failure in the first compute unit.

Some example technical solutions implemented by some preferred embodiments are listed below.
1. A system for deployment of an autonomous vehicle, comprising: a first compute unit configured to: receive first information of the vehicle and an environment of the vehicle, generate a first control command based on the first information, and transmit the first control command to a controller of the vehicle to effectuate an autonomous operation of the vehicle; and a second compute unit configured to: receive second information of the vehicle and the environment of the vehicle, generate a second control command based on the second information, and only when a fault or failure of the first compute unit is detected, transmits the second control command to a controller of the vehicle to effectuate the autonomous operation of the vehicle.
2. The system of any one of the solutions herein, wherein the first information is substantially equivalent to the second information.
3. The system of any one of the solutions herein, wherein the first information and the second information include same sensor data acquired by at least one sensor.
4. The system of any one of the solutions herein, wherein the at least one sensor comprises at least one of a camera, an audio sensor, a light detection and ranging (LiDAR) sensor, a radar sensor, or a navigation sensor.
5. The system of any one of the solutions herein, further comprising: a first sensor unit configured to receive a first portion of the sensor data from a first group of the at least one sensor, and a second sensor unit configured to receive a second portion of the sensor data from a second group of the at least one sensor.
6. The system of any one of the solutions herein, wherein the first sensor unit and the second sensor unit are implemented on a blade module.
7. The system of any one of the solutions herein, wherein the blade module including the first sensor unit and the second sensor unit comprise a front panel and a backplane, the front panel including at least one interface configured to facilitate communication of the first sensor unit and the second sensor unit with the at least one sensor, and the backplane including at least one connector configured to facilitate communication of the first sensor unit and the second sensor unit with at least one of the first compute unit or the second compute unit.
8. The system of any one of the solutions herein, wherein the first sensor unit and the second sensor unit are connected to independent power sources, respectively.
9. The system of any one of the solutions herein, wherein the first sensor unit and the second sensor unit are operably coupled to the first compute unit via a first sensor data interface, and the first sensor unit and the second sensor unit are operably coupled to the second compute unit via a second sensor data interface that is independent of the first sensor data interface.
10. The system of any one of the solutions herein, wherein at least one of the first information or the second information comprises an operation parameter of the vehicle.
11. The system of any one of the solutions herein, wherein the first compute unit is operably coupled to a first power supply, and the second compute unit is operably coupled to a second power supply that is independent from the first power supply.
12. The system of any one of the solutions herein, wherein the first compute unit or the second compute unit comprises at least one of a central processing unit (CPU) module, a graphics processing unit (GPU) module, or a vehicle control unit (VCU).
13. The system of any one of the solutions herein, wherein the CPU module comprises at least one of a CPU unit, a CPU motherboard, a storage unit, a power connector, a PCIe connector, or an ethernet connector.
14. The system of any one of the solutions herein, wherein the GPU modules comprises at least one of a GPU unit, a GPU carrier board, a power connector, a switch, a microcontroller, or an ethernet connector.
15. The system of any one of the solutions herein, wherein a configuration of the first computer unit is substantially the same as a configuration of the second compute unit.
16. The system of any one of the solutions herein, further comprising a master timer configured to synchronize the first compute unit and the second compute unit.
17. The system of any one of the solutions herein, wherein the first compute unit includes a first vehicle control unit (VCU) operably coupled to an electronic control unit (ECU) via a first VCU-ECU connection, and
the second compute unit includes a second VCU operably coupled to the ECU via a second VCU-ECU connection that is independent from the first VCU-ECU connection.
18. The system of any one of the solutions herein, wherein at least one of the first compute unit or the second compute unit is implemented on a blade module.
19. The system of any one of the solutions herein, wherein the system is configured as a blade server comprising one or more blade modules where at least one of the first compute unit or the second compute unit is implemented.
20. The system of any one of the solutions herein, wherein the system is configured as a blade server comprising a plurality of blade modules where at least one of the first compute unit or the second compute unit is implemented, and the plurality of blade modules are operably connected with each other through a backplane.
21. The system of any one of the solutions herein, wherein the system is scalable by at least one of: adding an additional blade module, replacing or removing one of the plurality of blade modules, or modifying a configuration of one of the plurality of blade modules.
22. The system of any one of the solutions herein, wherein at least one of the first compute unit or the second compute unit is implemented with at least one of a dynamic driving task (DDT) software (SW) module or a diagnostics monitor SW module.
23. A method for deploying an autonomous vehicle, comprising: on a first compute unit, receiving first information of the vehicle and an environment of the vehicle, generating a first control command based on the first information, and transmitting the first control command to a controller of the vehicle to effectuate an autonomous operation of the vehicle; and on a second compute unit, receiving second information of the vehicle and the environment of the vehicle, generating a second control command based on the second information, and in response to detecting a fault or failure of the first compute unit, transmitting the second control command to the vehicle to effectuate the autonomous operation of the vehicle.
24. The method of any one of the solutions herein, wherein the first information is substantially equivalent to the second information.
25. The method of any one of the solutions herein, wherein the receiving of the first information on the first compute unit and the receiving of the second information on the second compute unit occur substantially simultaneously.
26. The method of any one of the solutions herein, further comprising: (periodically or not) comparing, on a VCU on the first compute unit or on the second compute unit, the first control command and the second control command; and determining whether a difference between the first control command and the second control command exceeds a threshold.
27. The method of any one of the solutions herein, further comprising: converting the first control command or the second control command to a control signal; and transmitting the control signal to an actuator of the vehicle via an ECU.
28. The method of any one of the solutions herein, wherein the control signal comprises at least one of an engine torque request, a brake request, or a steering wheel angle request.
29. The method of any one of the solutions herein, further comprising: detecting that the fault or failure of the first compute unit has occurred; and terminating the transmission of the first control command to the vehicle.
30. A non-transitory computer readable program storage medium having code stored thereon, the code, when executed by a processor, causing the processor to implement a method for deploying an autonomous vehicle, the method comprising: on a first compute unit, receiving first information of the vehicle and an environment of the vehicle, generating a first control command based on the first information, and transmitting the first control command to a controller of the vehicle to effectuate an autonomous operation of the vehicle; and on a second compute unit, receiving second information of the vehicle and the environment of the vehicle, generating a second control command based on the second information, and in response to detecting a fault or failure of the first compute unit is detected, transmitting the second control command to a controller of the vehicle to effectuate the autonomous operation of the vehicle.
31. A system for deployment on an autonomous vehicle, comprising: the first compute unit recited in any of the above solutions herein, the second compute unit recited in any of the above claims; and a vehicle controller configured to receive the first control commands from the first compute unit and the second control commands from the second control unit and selectively use one of the first control commands or the second control commands according to a redundancy rule.
32. The system of any one of the solutions herein, wherein the redundancy rule specifies to use the first control commands as a default option, and switch to the second control commands in response to detecting a fault or failure in the first compute unit.
33. The system of any one of the solutions herein, further comprising an oversight sub-system, wherein the oversight sub-system is configured to detect that a fault or failure have occurred in both the first compute unit and the second compute unit; and activate an emergency maneuver.
34. The system of any one of the solutions herein, wherein the emergency maneuver comprises causing the vehicle to a stop, generating a notification, giving control of the vehicle to a third party. Various embodiments of this system solution are described throughout and with respect to FIGS. 1 to 12.

It will be appreciated that the present document discloses a system for deployment on an autonomous vehicle such as an autonomous truck for path planning and navigation control in a manner by which the system provides a unique redundancy solution to mitigate failures in operation of a primary system. In one example aspect, the system is made failsafe by allowing multiple identical implementations to run independent of each other (e.g., separate hardware) while at the same time coordinating each other's processing such that same path planning commands are issued by all systems based on sensor inputs from sensors on the vehicle. At a given time, at least one of the systems is configured to monitor failures (e.g., deviations between different implementations or some other operational scenario) and instruct the vehicle to perform an emergency maneuver that avoids hazardous situations on road. In another example aspect, because a primary system and one or more backup systems may be providing path planning and control instructions at all times to a vehicle controller, the switching between a primary system and a redundant system is practically instantaneous. It will further be appreciated that the system design includes a star topology for data communication where latency is important and a bus, a switch or a multicast topology where configuration flexibility is desired. For example, sensor inputs are multicast, while sensor data processing performed by multiple GPUs may be communicated with dedicated point-to-point connections.

While several embodiments have been provided in this document, it should be understood that the disclosed systems and methods might be embodied in many other specific forms without departing from the spirit or scope of this document. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this document. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

Implementations of the subject matter and the functional operations described in this patent document can be implemented in various systems, semiconductor devices, ultrasonic devices, digital electronic circuitry, or in computer software, firmware, or hardware, including the structures disclosed in this specification and their structural equivalents, or in combinations of one or more of them. Implementations of aspects of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming languages, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of characteristics that may be specific to particular embodiments or sections of particular inventions. Certain characteristics that are described in this patent document in the context of separate embodiments or sections can also be implemented in combination in a single embodiment or a single section. Conversely, various characteristics that are described in the context of a single embodiment or single section can also be implemented in multiple embodiments or multiple sections separately or in any suitable sub combination. A feature or operation described in one embodiment or one section can be combined with another feature or another operation from another embodiment or another section in any reasonable manner. Moreover, although characteristics may be described above as acting in certain combinations and even initially claimed as such, one or more characteristics from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A system for deployment on an autonomous vehicle, comprising:
a first compute unit configured to:
receive first information of the vehicle and an environment of the vehicle,
generate a first control command based on the first information, and
transmit the first control command to a controller of the vehicle to effectuate an autonomous operation of the vehicle; and
a second compute unit configured to:
receive second information of the vehicle and the environment of the vehicle,
generate a second control command based on the second information, and
only when a fault or failure of the first compute unit is detected, transmits the second control command to the controller of the vehicle to effectuate the autonomous operation of the vehicle.

2. The system of claim 1, wherein the first information is substantially equivalent to the second information.

3. The system of claim 1, wherein the first information and the second information include same sensor data acquired by at least one sensor.

4. The system of claim 3, wherein the at least one sensor comprises at least one of a camera, an audio sensor, a light detection and ranging (LiDAR) sensor, a radar sensor, or a navigation sensor.

5. The system of claim 3, further comprising:
a first sensor unit configured to receive a first portion of the sensor data from a first group of the at least one sensor, and
a second sensor unit configured to receive a second portion of the sensor data from a second group of the at least one sensor.

6. The system of claim 5, wherein the first sensor unit and the second sensor unit are implemented on a blade module, and the blade module comprises a front panel and a backplane, the front panel including at least one interface configured to facilitate communication of the first sensor unit and the second sensor unit with the at least one sensor, and the backplane including at least one connector configured to facilitate communication of the first sensor unit and the second sensor unit with at least one of the first compute unit or the second compute unit.

7. The system of claim 5, wherein
the first sensor unit and the second sensor unit are operably coupled to the first compute unit via a first sensor data interface, and
the first sensor unit and the second sensor unit are operably coupled to the second compute unit via a second sensor data interface that is independent of the first sensor data interface.

8. The system of claim 1, wherein the first compute unit or the second compute unit comprises at least one of a central processing unit (CPU) module, a graphics processing unit (GPU) module, or a vehicle control unit (VCU).

9. The system of claim 1, wherein a configuration of the first computer unit is substantially the same as a configuration of the second compute unit.

10. The system of claim 1, further comprising a master timer configured to synchronize the first compute unit and the second compute unit.

11. The system of claim 1, wherein
the system is configured as a blade server comprising a plurality of blade modules where at least one of the first compute unit or the second compute unit is implemented, and
the plurality of blade modules are operably connected with each other through a backplane.

12. The system of claim 11, wherein the system is scalable by at least one of:
adding an additional blade module,
replacing or removing one of the plurality of blade modules, or
modifying a configuration of one of the plurality of blade modules.

13. The system of claim 1, wherein at least one of the first compute unit or the second compute unit is implemented with at least one of a dynamic driving task (DDT) software (SW) module or a diagnostics monitor SW module.

14. A method for deploying an autonomous vehicle, comprising:
on a first compute unit,
receiving first information of the vehicle and an environment of the vehicle,
generating a first control command based on the first information, and
transmitting the first control command to a controller of the vehicle to effectuate an autonomous operation of the vehicle; and
on a second compute unit,
receiving second information of the vehicle and the environment of the vehicle,
generating a second control command based on the second information, and
in response to detecting a fault or failure of the first compute unit, transmitting the second control command to the vehicle to effectuate the autonomous operation of the vehicle.

15. The method of claim 14, wherein the receiving of the first information on the first compute unit and the receiving of the second information on the second compute unit occur substantially simultaneously.

16. The method of claim 14, further comprising:
periodically comparing, on a VCU on the first compute unit or on the second compute unit, the first control command and the second control command; and
determining whether a difference between the first control command and the second control command exceeds a threshold.

17. The method of claim 14, further comprising:
detecting that the fault or failure of the first compute unit has occurred; and
terminating the transmission of the first control command to the vehicle.

18. A system for deployment on an autonomous vehicle, comprising:
a vehicle controller,
a first compute unit configured to:
receive first information of the vehicle and an environment of the vehicle,
generate a first control command based on the first information, and
transmit the first control command to the vehicle controller,
a second compute unit configured to:
receive second information of the vehicle and the environment of the vehicle,
generate a second control command based on the second information, and
transmit the second control command to the vehicle controller, wherein
the vehicle controller is configured to receive the first control commands from the first compute unit and the second control commands from the second control unit and selectively use one of the first control commands or the second control commands according to a redundancy rule.

19. The system of claim 18, wherein the redundancy rule specifies to use the first control commands as a default option, and switch to the second control commands in response to detecting a fault or failure in the first compute unit.

20. The system of claim 18, further comprising an oversight sub-system, wherein the oversight sub-system is configured to
detect that fault or failure has occurred in both the first compute unit and the second compute unit; and
activate an emergency maneuver.
